(19) United States
(12) Patent Application Publication
(10) Pub. No.: US 2004/0169684 A1
(43) Pub. Date: Sep. 2, 2004

(54) Linking images for navigation

(76) Inventors: Dave Orth, Corvallis, OR (US); Donald X. Smith II, Corvallis, OR (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/377,077

(22) Filed: Feb. 28, 2003

(51) Int. Cl. G09G 5/00

(52) U.S. Cl. 345/804; 345/854

(57) ABSTRACT

Various systems, methods, and computer programs embodied in a computer readable medium for linking images are provided. In one embodiment, a method is provided that comprises the steps of identifying a number of components in a primary image in a computer system, and automatically matching each of the components with one of a number of component images in the computer system. Also, a navigation output such as a link is generated that links each of the components in the primary image with a respective one of the component images.

### BACKGROUND

It is often the case that images displayed as a portion of a website, for example, may be linked to provide for navigation therebetween. In some situations, it may be desirable to link a component of a first image to a second image that shows the component within a single image that may provide a larger or more direct view. For example, one may wish to link individual members of a sports team in a team photo to individual photos of each team member. This allows navigation from the image of the team to each one of the images of the individual team members. Unfortunately, to do so often requires a lot of time and expertise to generate the required output file such as, for example, a hypertext markup language file (HTML) to facilitate such navigation.

### BRIEF DESCRIPTION OF THE SEVERAL VIEWS OF THE DRAWINGS

The invention can be understood with reference to the following drawings. The components in the drawings are not necessarily to scale. Also, in the drawings, like reference numerals designate corresponding parts throughout the several views.

FIG. 1 is a schematic of a computer system that executes an image linking system according to an embodiment of the present invention;

FIG. 2 is a drawing of a primary image that is stored in a memory of the computer system of FIG. 1 according to an embodiment of the present invention;

FIG. 3 is a drawing of a number of component images that are stored in a memory of the computer system of FIG. 1 according to an embodiment of the present invention;

FIG. 4 is a drawing of a user interface that illustrates the primary image of FIG. 2 with a selection of a selection region surrounding a component in the primary image according to an embodiment of the present invention;

FIG. 5 is a drawing of a user interface that illustrates one of the component images of FIG. 3, wherein the component image is linked to the primary image according to an embodiment of the present invention;

FIG. 6 is a drawing of a user interface that provides for a manual confirmation of matches between components within the primary image of FIG. 2 and respective ones of the component images of FIG. 3 according to an embodiment of the present invention; and

FIG. 7 is an exemplary flow chart of the image linking system of FIG. 1 according to an embodiment of the present invention.

### DETAILED DESCRIPTION

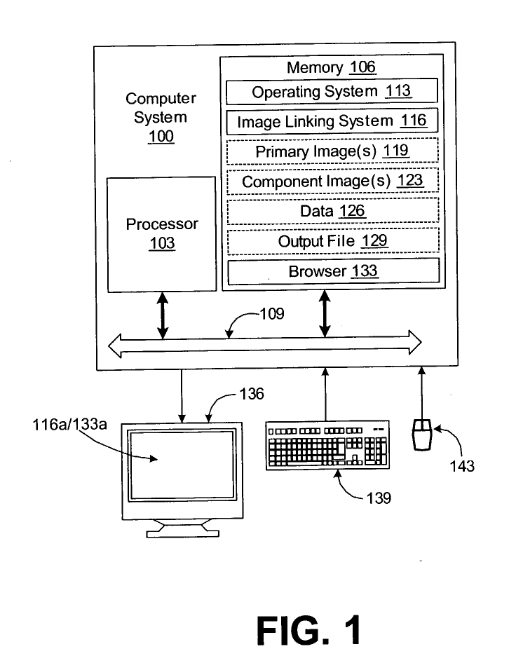

With reference to FIG. 1, shown is a schematic of a computer system 100 according to an embodiment of the present invention. In this respect, the computer system 100 includes a processor circuit having a processor 103 and a memory 106, both of which are coupled to a local interface 109. The local interface 109 may be, for example, a data bus with an accompanying control/address bus as can be appreciated by those with ordinary skill in the art. The computer system 100 may be a standard computer system or other device or system with like capability.

Several components are stored in the memory 106 and are executable by the processor 103. These components comprise, for example, an operating system 113, an image linking system 116, one or more primary images 119, one or more component images 123, data 126 that is associated with the one or more component images 123, and an output file 129 that is generated by the image linking system 116. In addition, a browser 133 or other similar system may also be stored in the memory 106 and executable by the processor 103.

As will be discussed, the image linking system 116 is executed to generate a navigation output that links each of a number of components in the primary image 119 to a respective one of the component images 123. The navigation output may be generated in the form of an output file 129 that is expressed in an appropriate computer language. The computer languages include, for example, markup languages such as hypertext markup language (HTML), extensible markup language (XML), or other markup languages. The computer language may also comprise, for example, C++, Perl, Java, Phython, C, Flash or other appropriate languages.

In addition, a number of peripheral devices are coupled to the computer system 100. Such peripheral devices comprise, for example, a display device 136, a keyboard 139, and a mouse 143. In addition, further peripheral devices that may be employed with the computer system 100 include keypads, touch pads, touch screens, microphones, scanners, joysticks, or one or more push buttons, etc. The peripheral devices may also include indicator lights, speakers, printers, etc. The display device 136 may be, for example, a cathode ray tube (CRT), liquid crystal display screen, gas plasma-based flat panel display, or other type of display device, etc.

During execution, the image linking system 116 may generate a user interface 116a on the display device 136. Similarly, the browser 133 may generate one or more user interfaces 133a that include, for example, web pages or other content that may be expressed in an appropriate markup language or other appropriate language, etc. The user may interact with the user interfaces 116a/133a by manipulating the keyboard 139 and/or the mouse 143 or other input device as can be appreciated by those with ordinary skill in the art.

The memory 106 is defined herein as both volatile and nonvolatile memory and data storage components. Volatile components are those that do not retain data values upon loss of power. Nonvolatile components are those that retain data upon a loss of power. Thus, the memory 106 may comprise, for example, random access memory (RAM), read-only memory (ROM), hard disk drives, floppy disks accessed via an associated floppy disk drive, compact discs accessed via a compact disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

In addition, the processor 103 may represent multiple processors and the memory 106 may represent multiple memories that operate in parallel. In such a case, the local interface 109 may be an appropriate network that facilitates communication between any two of the multiple processors, between any processor and any one of the memories, or between any two of the memories etc.

Also, the operating system 113 is executed to control the allocation and usage of hardware resources in the computer system 100 such as the memory 106, processing time and peripheral devices. In this manner, the operating system 113 serves as the foundation on which applications depend as is generally known by those with ordinary skill in the art.

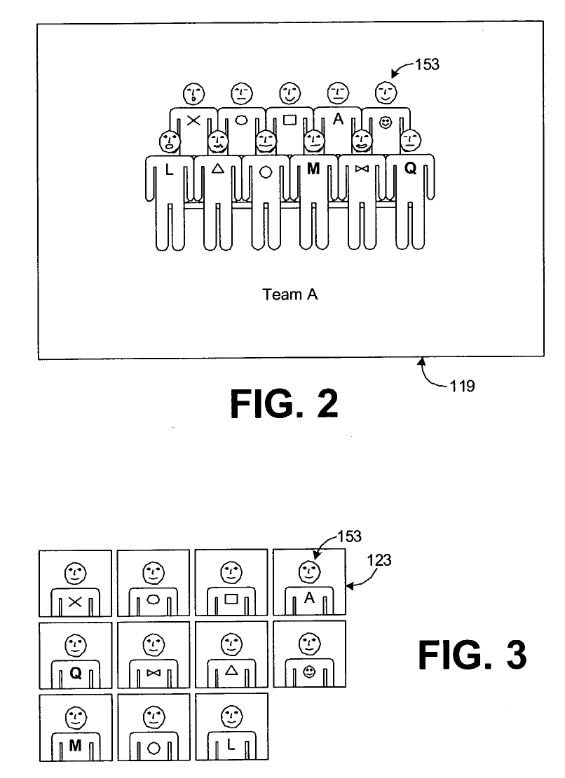

Turning then, to FIG. 2, shown is an example of a primary image 119 according to an embodiment of the present invention. The primary image 119 includes a number of components 153 that may comprise, for example, images of objects, people, characters, or other images.

Referring to FIG. 3, shown are examples of a number of component images 123 according to an embodiment of the present invention. Similar to the components 153 (FIG. 2), the component images 123 may comprise, for example, images of objects, people, characters, or other images. In one embodiment, each of the component images 123 includes one of the components 153. The component images 123 may or may not be identical to the components 153 within the primary image 119. For example, in one case the component images 123 and the corresponding components 153 may be different images of the same subject matter or component. As such, the component images 123 are not identical to the corresponding components 153 in the primary image 119. Alternatively, each of the component images 123 may comprise a portion of the primary image 119 that includes a respective one of the components 153 such that the component images 123 are identical to their respective components 153 as depicted in the primary image 119. It may also be the case, for example, that each of the component images 123 may include a number of the components 153. Thus, the primary image 119 (FIG. 2) and the component images 123 are related in that each of the component images 123 includes at least one of the components 153 that are collectively displayed in the primary image 119.

In certain circumstances, a user may wish to navigate from the primary image 119 to each of the component images 123 such as would be the case when navigating from image to image on the World Wide Web. According to the present invention, the image linking system 116 (FIG. 1) provides for the creation of an output file 129 that includes links between the primary image 119 and each one of the component images 123 as will be discussed.

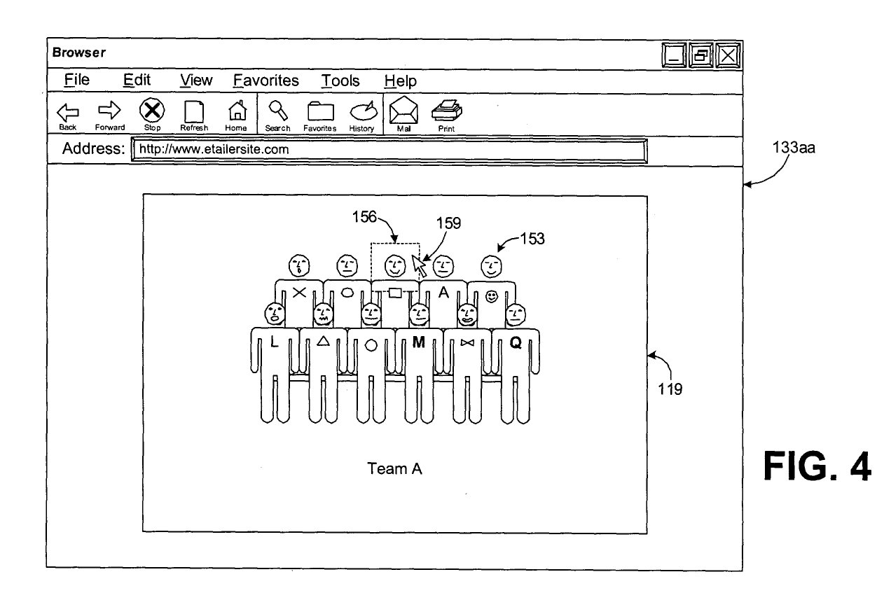

Referring next to FIG. 4, shown is an exemplary user interface 133aa according to an embodiment of the present invention. As shown, the graphical user interface 133aa is generated, for example, by the browser 133 (FIG. 1), although a similar interface may be generated by other applications. The user interface 133aa includes the primary image 119. Within the primary image 119 are the components 153. Also, one or more selection regions 156 are included within the primary image 119. Each of the selection regions 156 encloses at least one of the components 153 and is associated with a link to a corresponding one of the component images 123 (FIG. 3). A user may position a cursor 159 over one of the selection regions 156 by manipulating the mouse 143 (FIG. 1) or by manipulating some other input device as can be appreciated by those with ordinary skill in the art. The user may select the selection region 156 by a “clicking” there on. This may be done, for example, by pressing a button on the mouse 143 or by performing some other action as can be appreciated by those with ordinary skill in the art. When the cursor 159 is maneuvered over the selection region 156, the selection region 156 may become highlighted, thereby a indicating the borders of the selection region 156 as can be appreciated by those with ordinary skill in the art.

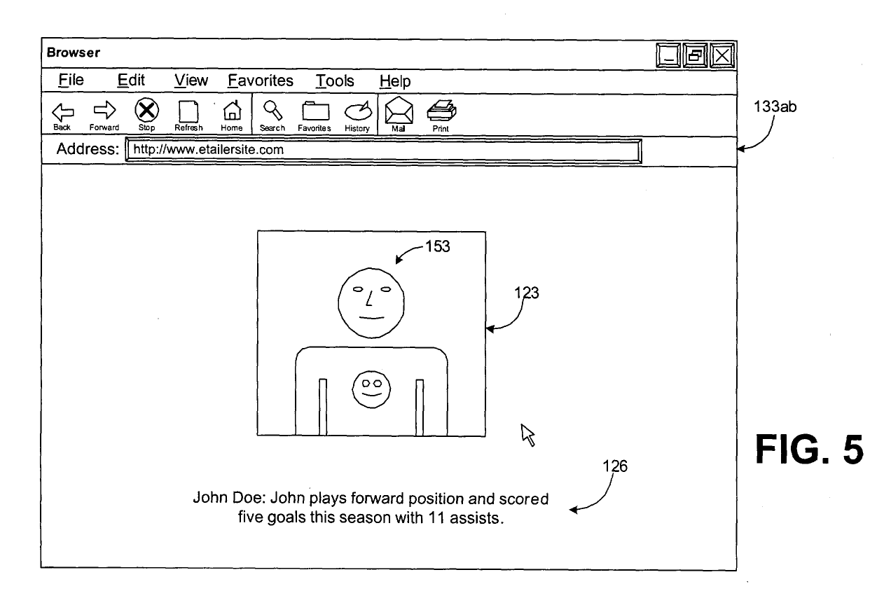

With reference to FIG. 5, shown is a user interface 133ab that depicts a component image 123. The component image 123 includes an identical or non-identical depiction of at least one of the components 153 that are depicted in the primary image 119. In addition, an amount of data 126 that is associated with the component image 123 is also depicted in the user interface 133ab. By virtue the fact that the user has clicked on or otherwise selected the selection region 156 (FIG. 4), the browser 133 causes the component image 123 associated therewith to be displayed accordingly. In this respect, the browser 133 may interpret an appropriate file that includes a link that associates the component image 123 with the selection region 156/component 153.

In addition, any data 126 that is associated with the component image 123 is also displayed. In this respect, the selection region 156 and the component image 123 are associated with each other. Thus, the respective component 153 within the primary image 119 is linked to the component image 123 using an appropriate file such as, for example, a Markup file or other type of file that provides for the linking of each of the components 153 in the primary image with a respective one of the component images 123. Such a file may be, for example, an HTML file, an XML file, or other type of file as can be appreciated by those with ordinary skill in the art.

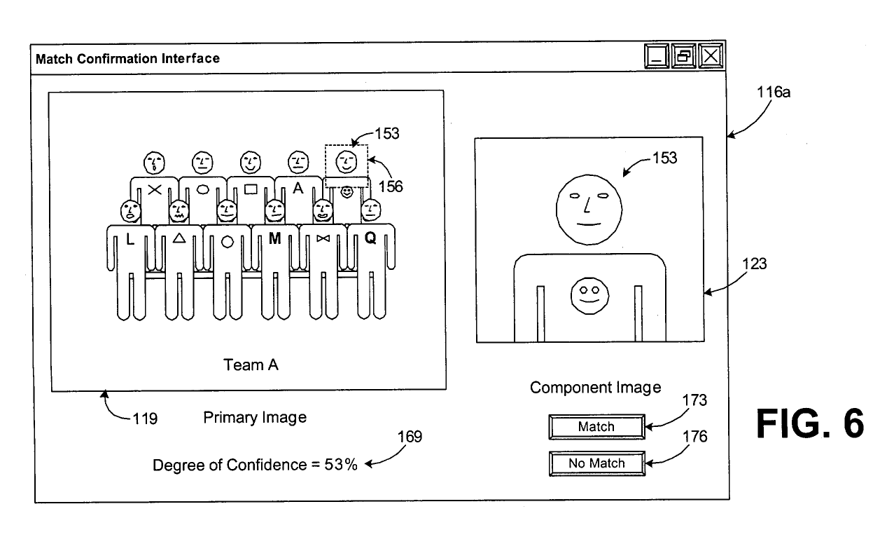

Referring next to FIG. 6, shown is an exemplary user interface 116a generated by the image linking system 116 (FIG. 1) that provides for a manual confirmation of an automated match between a component 153 and one of the component images 123. Specifically, the user interface 116a depicts the primary image 119 and one of the secondary images 123. One of the components 153 in the primary image 119 is highlighted. The user interface 116a also depicts a degree of confidence 169 of a match between the highlighted component 153 and the component image 123. The user interface 116a also includes a “match” button 173 and a “No Match” button 176 that are manipulated by a user to confirm or deny a particular match is accurate.

According to an embodiment of the present invention, the image linking system 116 attempts to perform an automated matching of each of the components 153 in the primary image 119 and at least one of the component images 123. For each match, the image linking system 116 calculates the degree of confidence 169 that the match is accurate based upon the similarities in appearance between the respective component 153 and the component image 123. If the degree of confidence 169 falls below a predefined threshold or is otherwise unacceptable, then the image linking system 116 generates the user interface 116a to provide for a manual confirmation of the respective match. If the user perceives that the match is correct, then they may manipulate the “match” button 173. Conversely, if the match is incorrect, then the user may manipulate the “no match” button 176 to inform the image linking system 116 that the match was incorrect. If the match is deemed incorrect, then the image linking system 116 eliminates the prospective match between the respective component 153 and the component image 123. In such case, the component 153 and the component image 123 remain unmatched.

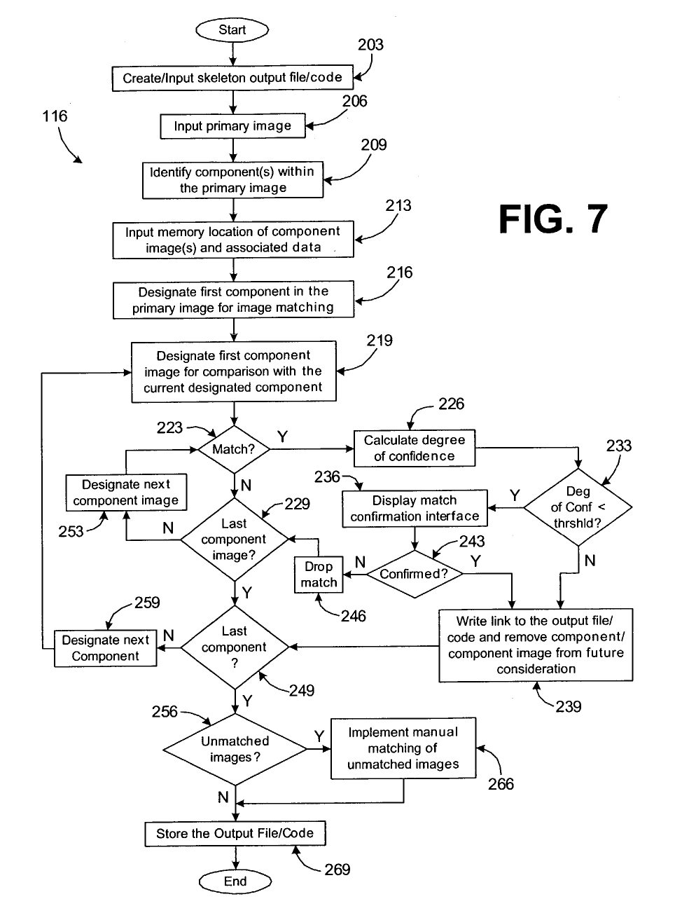

Referring next to FIG. 7, shown is an exemplary flow chart of the image linking system 116 according to an embodiment of the present invention. Alternatively, the flow chart of FIG. 7 may be viewed as depicting steps of a method implemented in the computer system 100 to create a navigation output that links each of the components 153 (FIG. 2) with one of the component images 123 (FIG. 3). The functionality of the image linking system 116 as depicted by the exemplary flow chart of FIG. 7 may be implemented, for example, in an object oriented design in which each block represents functionality that may be implemented in one or more methods that are encapsulated in one or more objects. The image linking system 116 may be implemented using any one of a number of programming languages such as, for example, C, C++, JAVA, Perl, Python, Flash, or other programming languages.

Beginning with box 203, the image linking system 116 creates or inputs a skeleton output file or output code. The output file or code is created in a “skeleton” format in that it does not link any one of the components 153 (FIG. 2) with any of the component images 123 (FIG. 3). Next, in box 206 the primary image 119 (FIG. 1) is received by the image linking system 116 as an input from a user. In this regard, the user may indicate the location of the primary image 119 in memory for access by the image linking system 116, for example, by manipulating an appropriate interface (not shown). Thereafter, in box 209 the image linking system 116 provides for the identification of each of the components 153 within the primary image 119. This may be done, for example, by executing an image recognition routine that automatically identifies the components 153 within the primary image 119. Such an image recognition routine may comprise, for example, face recognition technology or code that recognizes other types of objects or images, etc.

To provide one example, assume that the primary image 119 is a photograph of a sports team. In such case the image linking system 116 may employ face recognition technology to identify each individual person within the primary image 119 as a component 153 thereof. Also, other technology or code may be employed to recognize other objects based upon known features of such objects as can be appreciated by those with ordinary skill in the art.

Alternatively, the components 153 within the primary image 119 may be identified using a manual process. In such a case, the image linking system 116 may facilitate a manual specification of each of the components 153 in the primary image 119. In order to facilitate the manual specification of the components 153 in the primary image 119, the image linking system 116 may facilitate, for example, the manual specification of one or more selection regions 156 that enclose or otherwise outline each of the components 153. In such a manner, each of the selection regions 156 includes at least one of the components 153. In order to accomplish such a manual specification of the components 153, appropriate user interfaces (not shown) may be employed as can be appreciated by those with ordinary skill in the art.

Once the components 153 have been identified in box 209, then the image linking system 116 proceeds to box 213. In box 213 a memory location of the component images 123 is received as an input from the user, for example, or the user may provide one or more appropriate inputs that identify the component images 123 for the image linking system 116. The image linking system 116 may generate one or more user interfaces (not shown) to facilitate the input of the memory location of each of the component images 123 or to input the component images 123 themselves. Thereafter, in box 216, a first one of the components 153 identified in the primary image 119 is designated for image matching. Thereafter, in box 219, a first one of the component images 123 is designated for comparison with the above designated component 153 to determine whether a match exists there between.

Thereafter, in box 223, the image linking system 116 automatically determines whether a match exists between the current designated component 153 and the current designated component image 123. This may be done, for example, by comparing the similarity of features within the respective images as can be appreciated by those with ordinary skill in the art. For example, in appropriate cases where the current designated component 153 and component image 123 include faces, a face recognition system may be employed to facilitate automated matching between the current designated component 153 and the current designated component image 123. Also, the image linking system 116 may execute other systems or code to obtain an automated matching of objects depicted in the current designated component 153 and component image 123. If the image linking system 116 determines that a match exists in box 223, then the image linking system 116 proceeds to box 226. Otherwise, the image linking system 116 moves to box 229.

In box 226, the image linking system 116 calculates or otherwise determines the degree of confidence 169 (FIG. 6) of the accuracy of the match between the current designated component 153 and the current designated component image 123. The degree of confidence 169 may be calculated, for example, based upon the similarity between features of the current designated component 153 and the current designated component image 123. Thereafter, in box 233, if the image linking system 116 determines that the degree of confidence 169 is less than a predefined threshold or is otherwise unacceptable, then the image linking system 116 proceeds to box 236. Otherwise, the image linking system 116 progresses to box 239.

In box 236, the user interface 116a (FIG. 6) is generated by the image linking system 116 on the display device 136 so that the user may confirm the current match that was determined in box 223. As such, the current designated component 153 and the current designated component image 123 are both displayed in the user interface 116a. The image linking system 116 then proceeds to box 243 in which it is determined whether the user has input an indication that the match was confirmed as may be determined, for example, from a manipulation of the “Match” button 173. Assuming that the match between the current designated component 153 and component image 123 was confirmed in box 243, then the image linking system 116 proceeds to box 239. Otherwise, the image linking system 116 progresses to box 246 as shown.

In box 246, the current match is dropped and the component 153 and component image 153 are not removed from consideration for future matches. Thereafter, the image linking system 116 proceeds to box 229.

In box 239, the image linking system 116 generates a navigation output that is written to the output file 129 or output code that links the current designated component 153 and the current designated component image 123 for purposes of future navigation using, for example, a browser or other comparable system. In this respect, the navigation output may be, for example, a link such as a hyperlink that associates the component image 123 with the component 153. Such a link may be associated with a corresponding selection region 156 that outlines or encloses the component 153. Also, in box 239 the matched component 153 and component image 123 are removed from future consideration for other matches between remaining ones of the components 153 and the component images 123. Thereafter, the image linking system 116 moves to box 249.

Assuming that the image linking system 116 proceeds to box 229 from box 223 or 246, then the image linking system 116 determines whether the last component image 123 has been compared to the current designated component 153. If such is the case, then the image linking system 116 proceeds to box 249. Otherwise, the image linking system 116 moves to box 253. In box 253, the image linking system 116 designates the next component image 123 to compare with the current designated component 153. Thereafter, the image linking system 116 reverts back to box 223 to perform the next comparison as described above.

In box 249, the image linking system 116 determines whether the last component 153 has been considered for matching as described above. If so, then the image linking system 116 proceeds to box 256. Otherwise, the image linking system 116 moves to box 259. In box 259, the next component 153 is designated to be matched with one of the component images 123. Thereafter, the image linking system 116 reverts back to box 219.

In box 256, the image linking system 116 determines whether any components 153 and/or any component images 123 remain that have not been the subject of a successful match in box 223 for which an appropriate link was written to the output file 129 or output code in box 239. If such is the case, then the image linking system 116 proceeds to box 266. Otherwise, the image linking system 116 proceeds to box 269. In box 266 the image linking system 116 implements a manual matching of the remaining unmatched components 153 and the component images 123. In this respect, one or more user interfaces (not shown) may be employed to facilitate the manual matching of the remaining unmatched components 153 and the component images 123. For each manual match identified, an appropriate link is created in the output file 129 or output code. Thereafter, the image linking system 116 proceeds to box 269.

In box 269, the output file 129 or output code that was generated in boxes 203 and 239 is stored in appropriate memory location for future access by the user using a browser 133 (FIG. 1) or other application. Thereafter, the image linking system 116 ends accordingly.

Although the image linking system 116 is embodied in software or code executed by general purpose hardware as discussed above, as an alternative the image linking system 116 may also be embodied in dedicated hardware or a combination of software/general purpose hardware and dedicated hardware. If embodied in dedicated hardware, the image linking system 116 can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, programmable gate arrays (PGA), field programmable gate arrays (FPGA), or other components, etc. Such technologies are generally well known by those skilled in the art and, consequently, are not described in detail herein.

The flow chart of FIG. 7 shows the architecture, functionality, and operation of an implementation of the image linking system 116. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor in a computer system or other system. The machine code may be converted from the source code, etc. If embodied in hardware, each block may represent a circuit or a number of interconnected circuits to implement the specified logical function(s).

Although the flow chart of FIG. 7 shows a specific order of execution, it is understood that the order of execution may differ from that which is depicted. For example, the order of execution of two or more blocks may be scrambled relative to the order shown. Also, two or more blocks shown in succession in FIG. 7 may be executed concurrently or with partial concurrence. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present invention.

Also, where the image linking system 116 comprises software or code, it can be embodied in any computer-readable medium for use by or in connection with an instruction execution system such as, for example, a processor in a computer system or other system. In this sense, the logic may comprise, for example, statements including instructions and declarations that can be fetched from the computer-readable medium and executed by the instruction execution system. In the context of the present invention, a “computer-readable medium” can be any medium that can contain, store, or maintain the image linking system 116 for use by or in connection with the instruction execution system. The computer readable medium can comprise any one of many physical media such as, for example, electronic, magnetic, optical, electromagnetic, infrared, or semiconductor media. More specific examples of a suitable computer-readable medium would include, but are not limited to, magnetic tapes, magnetic floppy diskettes, magnetic hard drives, or compact discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Although the invention is shown and described with respect to certain embodiments, it is obvious that equivalents and modifications will occur to others skilled in the art upon the reading and understanding of the specification. The present invention includes all such equivalents and modifications, and is limited only by the scope of the claims.

I/we claim:

1. A method for linking images, comprising the steps of:
identifying a number of components in a primary image in a computer system;
automatically matching each of the components with one of a number of component images in the computer system; and
generating a navigation output that links each of the components in the primary image with a respective one of the component images.

2. The method of claim 1, wherein the step of generating the navigation output that links each of the components in the primary image with the respective one of the component images further comprises the step of generating an output file that comprises a number of links that associate one of the component images with each of the components.

3. The method of claim 2, wherein the step of generating the navigation output that links each of the components in the primary image with the respective one of the component images further comprises the step of specifying a number of selection regions on the primary image in the output file, each of the selection regions enclosing one of the components and being associated with one of the links.

4. The method of claim 1, further comprising the step of determining a degree of confidence of a match between one of the components and one of the component images.

5. The method of claim 4, further comprising the step of facilitating a manual confirmation of the match between the one of the components and the one of the component images if the degree of confidence is less than a predefined threshold.

6. The method of claim 1, wherein the step of identifying the number of components in the primary image in the computer system further comprises the step of automatically specifying of each of the components in the primary image.

7. A computer program embodied in a computer readable medium for linking images, comprising:
code that provides for an identification of a number of components in a primary image;
code that provides for an automated matching of each of the components with one of a number of component images; and
code that generates a navigation output that links each of the components in the primary image with a respective one of the component images.

8. The computer program embodied in the computer readable medium of claim 7, wherein the code that generates the navigation output that links each of the components in the primary image with the respective one of the component images further comprises code that generates an output file that comprises a number of links that associate one of the component images with each of the components.

9. The computer program embodied in the computer readable medium of claim 8, wherein the code that generates the navigation output that links each of the components in the primary image with the respective one of the component images further comprises code that specifies a number of selection regions on the primary image in the output file, each of the selection regions enclosing one of the components and being associated with one of the links.

10. The computer program embodied in the computer readable medium of claim 7, further comprising code that determines a degree of confidence of the match between one of the components and one of the component images.

11. The computer program embodied in the computer readable medium of claim 10, further comprising code that facilitates a manual confirmation of the match between the one of the components and the one of the component images if the degree of confidence is less than a predefined threshold.

12. The computer program embodied in the computer readable medium of claim 7, wherein the code that provides for the identification of the number of components in the primary image further comprises code that automatically identifies each of the components in the primary image.

13. A system for linking images, comprising:
a processor circuit having a processor and a memory;
an image linking system stored in the memory and executable by the processor, the image linking system comprising:
logic that provides for an identification of a number of components in a primary image;
logic that provides for an automated matching of each of the components with one of a number of component images; and
logic that generates a navigation output that links each of the components in the primary image with a respective one of the component images.

14. The system of claim 13, wherein the logic that generates the navigation output that links each of the components in the primary image with the respective one of the component images further comprises logic that generates an output file that comprises a number of links that associate one of the component images with each of the components.

15. The system of claim 14, wherein the logic that generates the navigation output that links each of the components in the primary image with the respective one of the component images further comprises logic that specifies a number of selection regions on the primary image in the output file, each of the selection regions enclosing one of the components and being associated with one of the links.

16. The system of claim 13, further comprising logic that determines a degree of confidence of the match between one of the components and one of the component images.

17. The system of claim 16, further comprising logic that facilitates a manual confirmation of the match between the one of the components and the one of the component images if the degree of confidence is less than a predefined threshold.

18. The system of claim 13, wherein the logic that provides for the identification of the number of components in the primary image further comprises logic that automatically identifies each of the components in the primary image.

19. A system for linking images, comprising:
means for identifying a number of components in a primary image;
means for automatically matching each of the components with one of a number of component images; and
means for generating a navigation output that links each of the components in the primary image with a respective one of the component images.

20. The system of claim 19, wherein the means for generating the navigation output that links each of the components in the primary image with the respective one of the component images further comprises means for generating an output file that comprises a number of links that associate one of the component images with each of the components.

21. The system of claim 19, wherein the means for identifying the number of components in the primary image further comprises means for automatically identifying each of the components in the primary image.
